(19) United States
(12) Patent Application Publication
(10) Pub. No.: US 2006/0130618 A1
(43) Pub. Date: Jun. 22, 2006

(54) Sleeve with adaptable hole

(76) Inventor: Chih-Ching Hsieh, Taichung Hsien (TW)

Correspondence Address: Chih-Ching Hsieh, 235 Chung - Ho, Box 8-24, Taipei, TW

(21) Appl. No.: 11/017,601

(22) Filed: Dec. 21, 2004

(51) Int. Cl. B25B 13/06

(52) U.S. Cl. 81/121.1

(57) ABSTRACT

A sleeve with an adaptable hole comprises a sleeve body; a hole being formed at one end of the sleeve body; the hole having a plurality of concave cambered surface; for each two adjacent concave cambered surfaces, there are two convex cambered surfaces; a sharp pit being formed between the two convex cambered surfaces. Or at least one auxiliary resisting surface is installed between two adjacent concave cambered surfaces. The auxiliary resisting surface has one smooth surface facing a center of the hole. For each two adjacent concave cambered surfaces with the auxiliary resisting surface therebetween, there are two convex cambered surfaces; a sharp pit being formed between the two convex cambered surfaces.

### FIELD OF THE INVENTION

The present invention relates to sleeves, and in particular to a sleeve with an adaptable hole which has a special designed edge of the hole in the sleeve so that the sleeve can fit with various kinds of nuts.

### BACKGROUND OF THE INVENTION

In the prior art sleeve for clamping a nut, the specifications of the sleeve and nut must match to one another so that the nut can be fitted into the sleeve. However there are many different specifications for nuts. For example, in United Kingdom, for a nut of 1/16 inch, it is corresponding to a nut of 17.28 mm, but in U.S. the nut 17 mm is used, instead of 17.28 mm. Thereby an error is induced. Thereby the sleeve cannot completely fit the nut. To improve this defect, in one improve structure, the apex of the hole of the sleeve is rounded so as to fit the nut. As result in use, it will induce that the nut slides within the sleeve. For a long time, it will induce that the sleeve and nut is worn due to the stress is concentrated at one point. Further, the operation is inefficiency. In operation, it is frequently occurred that the sleeve is operated clockwise or counterclockwise repeatedly. This further make the sleeve and nut wear.

### SUMMARY OF THE INVENTION

Accordingly, the primary object of the present invention is to provide a sleeve with an adaptable hole which has a special designed edge of the hole in the sleeve so that the sleeve can fit with various kinds of nuts.

To achieve above objects, the present invention provides a sleeve with an adaptable hole which comprises a sleeve body; a hole being formed at one end of the sleeve body; the hole having a plurality of concave cambered surface; for each two adjacent concave cambered surfaces, there are two convex cambered surfaces; a sharp pit being formed between the two convex cambered surfaces. Or at least one auxiliary resisting surface is installed between two adjacent concave cambered surfaces. The auxiliary resisting surface has one smooth surface facing a center of the hole. For each two adjacent concave cambered surfaces with the auxiliary resisting surface therebetween, there are two convex cambered surfaces; a sharp pit being formed between the two convex cambered surfaces.

The various objects and advantages of the present invention will be more readily understood from the following detailed description when read in conjunction with the appended drawing.

### BRIEF DESCRIPTION OF THE DRAWINGS

FIG. 1 is a perspective view of the sleeve with an adaptable hole of the present invention.

FIG. 2 is a cross sectional view of the sleeve with an adaptable hole of the present invention.

FIGS. 3, 4, and 5 are schematic views showing the operation of the sleeve with an adaptable hole of the present invention.

FIG. 6 is a perspective view of the second embodiment of the present invention.

FIGS. 7 and 8 are schematic views showing the second embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

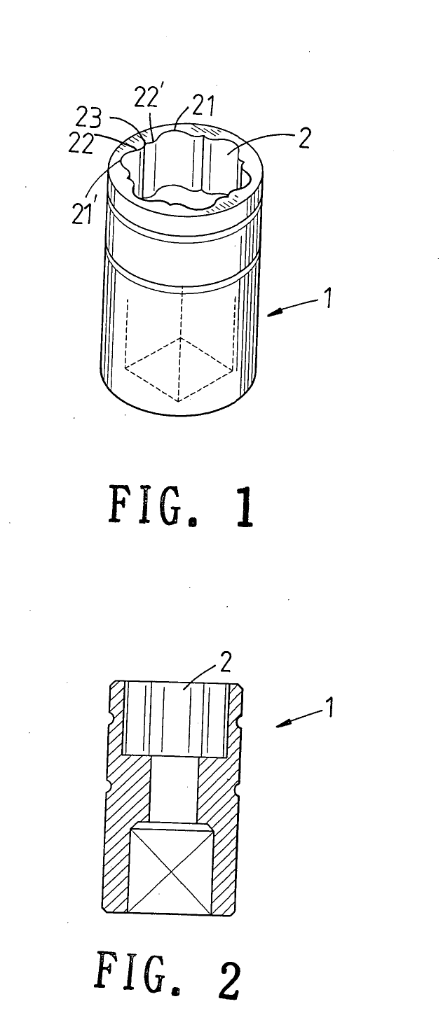

Referring to FIGS. 1 and 2, the structure of the present invention is illustrated. The present invention includes the following elements.

A sleeve body 1 is included.

A hole is formed at one end of the sleeve body 1. The hole has a plurality of concave cambered surface 21. For each two adjacent concave cambered surfaces 21, 21′, there are two convex cambered surfaces 22, 22′. A sharp pit 23 is formed between the two convex cambered surfaces 22, 22′.

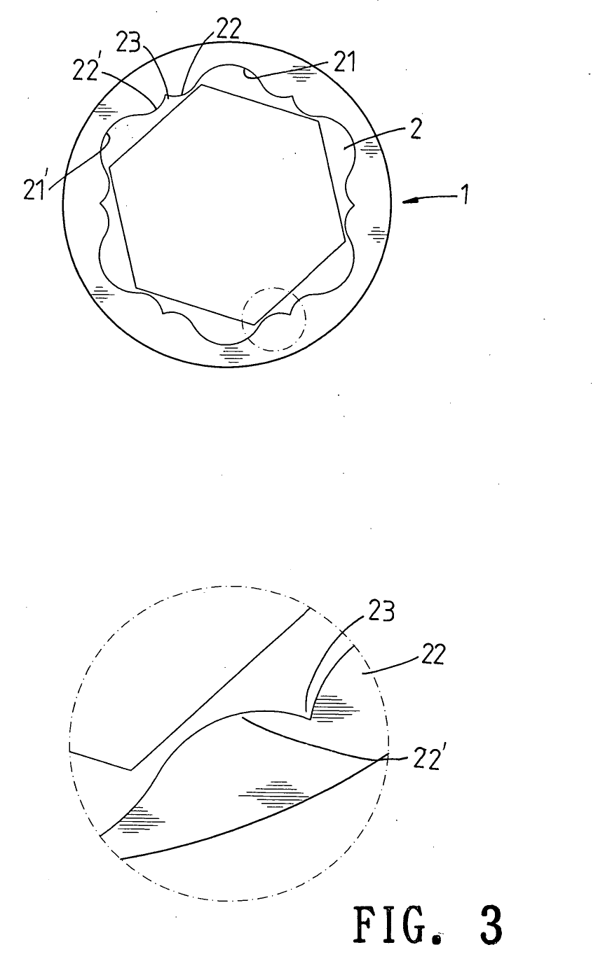

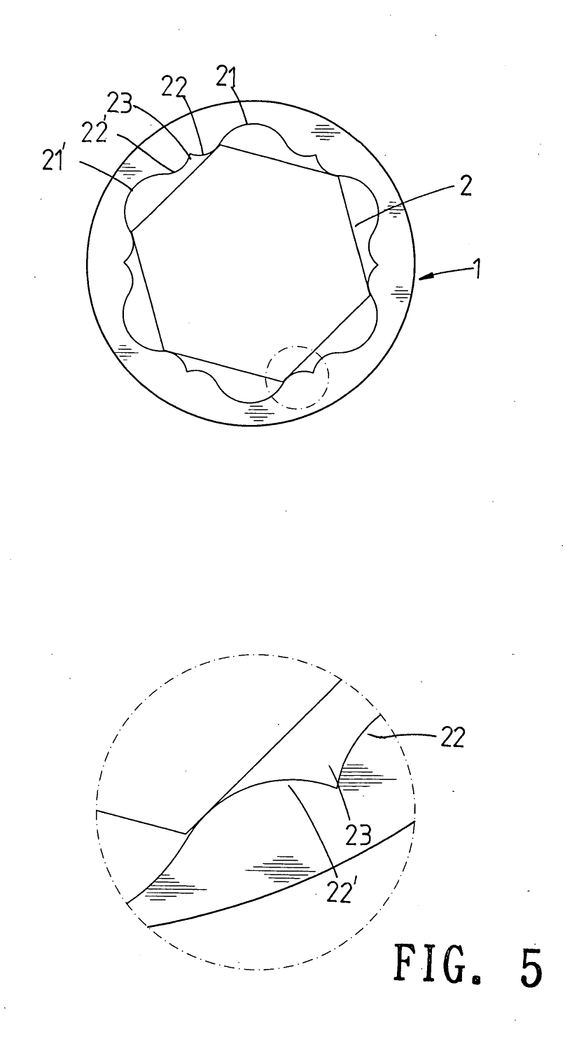

Referring to FIGS. 3 to 5, when the sleeve body 1 of the present invention is desired to engage with a nut of different specification, the nut can resist against the concave cambered surface 21 due to the design of the concave cambered surface 21.

In operation, when it is operated clockwise, one surface of the nut resists against one convex cambered surface 22, When the nut to be operated counterclockwise, another surface of the nut resists against another convex cambered surface 22′ at another side. Thereby the stress is dispersed and is thus wear-proofed.

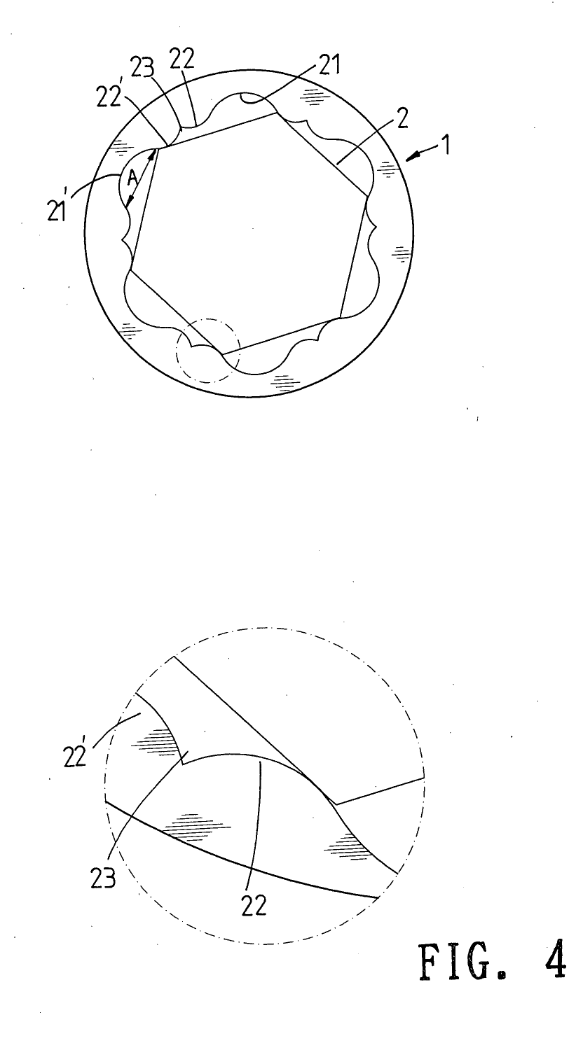

Furthermore, by the present invention, the conversion distance A for converting from clockwise operation to counterclockwise operation or vice versa can be reduced effectively so as to improve the efficiency of use, as shown in FIG. 4.

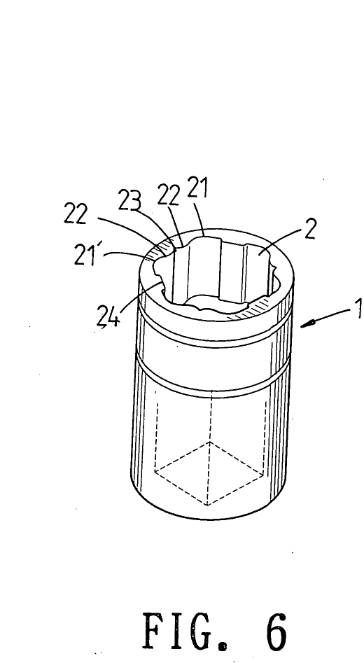

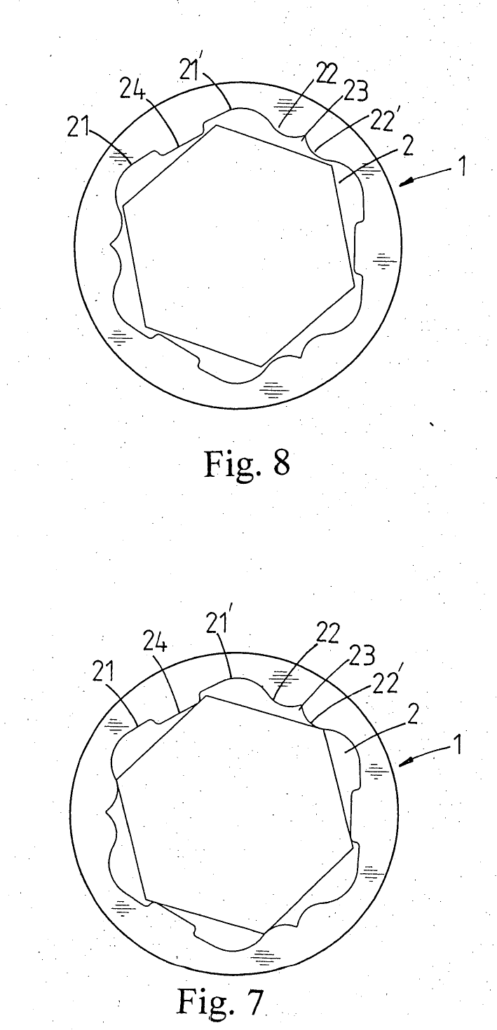

With reference to FIGS. 6 to 8, the second embodiment of the present invention is illustrated. In this embodiment, those identical to the first embodiment will not be described herein. The difference of the two will be described here. To have a structure-stable sleeve, in the present invention, at least one auxiliary resisting surface 24 is installed between two adjacent concave cambered surfaces 21, 21′. The auxiliary resisting surface 24 has one smooth surface facing a center of the hole 2. Thereby it has the function of enhancing the resisting effect of the nut to the auxiliary resisting surface 24.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A sleeve with an adaptable hole comprising:
a sleeve body;
a hole formed at one end of the sleeve body; the hole having a plurality of concave cambered surfaces; for each two adjacent concave cambered surfaces, there are two convex cambered surfaces; a sharp pit being formed between the two convex cambered surfaces.

2. A sleeve with an adaptable hole comprising:
a sleeve body;
a hole formed at one end of the sleeve body; the hole having a plurality of concave cambered surfaces;
at least one auxiliary resisting surface installed between two adjacent concave cambered surfaces; the auxiliary resisting surface having one smooth surface facing a center of the hole; and
for each two adjacent concave cambered surfaces with the auxiliary resisting surface therebetween, there are two convex cambered surfaces; and a sharp pit being formed between the two convex cambered surfaces.
